(19) United States
(12) Patent Application Publication
(10) Pub. No.: US 2024/0257402 A1
(43) Pub. Date: Aug. 1, 2024

(54) Systems and Methods for Creating Efficient Progressive Images

(71) Applicant: Six Impossible Things Before Breakfast Limited, Dublin (IE)

(72) Inventor: Sherry IGNATCHENKO, Weidling (AT)

(73) Assignee: Six Impossible Things Before Breakfast Limited, Dublin (IE)

(21) Appl. No.: 18/425,315

(22) Filed: Jan. 29, 2024

Related U.S. Application Data
(60) Provisional application No. 63/482,291, filed on Jan. 30, 2023.

(51) Int. Cl. G06T 9/00; G06T 15/04; G06T 17/00

(52) U.S. Cl. CPC G06T 9/00; G06T 15/04; G06T 17/00; G06T 2210/36

(57) ABSTRACT

Systems and methods for utilizing differential compression to create efficient progressive images are described herein. To produce a progressive image, a differential image may first be created by using a lowest-quality image of the progressive image stream as an initial reference image. The differential image created using the lowest-quality image may then be compressed and appended to a progressive image stream. The compressed differential image may then be decompressed and used to produce an undifferentiated image of the original image. If the undifferentiated image meets a desired image quality, the progressive image stream may be completed with the undifferentiated image. If the undifferentiated image does not meet a desired image quality, these steps may be repeated using the resultant undifferentiated image as the reference image until the undifferentiated image produced meets a desired image quality.

### RELATED APPLICATIONS

This application claims priority to U.S. Provisional Application No. 63/482,291, entitled “Method for Creating Heterogeneous Progressive Images,” filed on Jan. 30, 2023, the contents of which are incorporated herein by reference in their entirety.

### FIELD OF THE DISCLOSURE

The systems and methods described herein relate to the creation of progressive image streams as a means to encode textures for rendering computer-generated three-dimensional models.

### BACKGROUND

Progressive images are frequently used when rendering computer graphics. A progressive image is an image that, when rendered, starts off as low quality (or low resolution) and gradually increases over time while it is being downloaded. Progressive images are commonly used online because they create the perception that a site is faster or more responsive. An alternative to progressive images are images that are compressed using a “baseline” algorithm. These images load from top to bottom, rendering each line of pixels in full quality. Until the image is fully downloaded, a blank space may appear on the screen where the image would otherwise be. Rather than waiting until an image is fully downloaded, progressive images display their full image in lower quality. This initial rendering is replaced iteratively as versions of the image in higher quality are downloaded. Because an acceptable version of a progressive image typically takes roughly two-thirds the time of a baseline image to download, an end user may perceive the image loads faster when progressive images are used.

While there are certainly benefits to using progressive images, there are also drawbacks. One common method for creating a progressive image is to make a stream or file from a sequence of non-progressive pictures with gradually-increasing quality to imitate progressive rendering. However, this often results in a significant size increase, especially at lower bits-per-pixel (bpp) rates. Accordingly, image formats (such as AVIF and WebP) that are optimized for lower bpp rates often do not support progressive renderings. As such, there is a need in the art for improved technique(s) for creating progressive images that produce images of comparable quality but with a smaller size.

### SUMMARY OF THE DISCLOSURE

According to one aspect of the invention, the systems and methods described herein may utilize differential compression to compress and decompress a source image. In various implementations, the source image may comprise a texture used for rendering a computer-generated three-dimensional model. Using a reference image the same size as the source image, a differential image may be produced by calculating a differential pixel for each pixel of a source image and placing each differential pixel in a position corresponding to the position of the pixel of the source image used to calculate that differential pixel. For example, to calculate a differential pixel, a corresponding pixel of a reference image may be subtracted from the pixel of the source image. In some implementations, subtracting the corresponding pixel of the reference image from the pixel of the source image may comprise a per-component subtraction of RGB components of the corresponding pixel of the reference image from RGB components of the pixel of the source image. The differential image may then be compressed using an existing compression method. For example, the differential image may be compressed by applying a compression method associated with the AVIF, JPEG, or JPEG XL file formats.

According to another aspect of the invention, the systems and methods described herein may be configured to decompress a compressed differential image and produce an undifferentiated image that corresponds to the original source image. For example, to decompress the compressed differential image, an existing decompression method may be applied to the compressed differential image. The existing decompression method may comprise a method that is complementary to the compression method used to compress the differential image. An undifferentiated image may then be produced by calculating an undifferentiated pixel for each pixel of the decompressed differential image. For example, for each pixel of the decompressed differential image, an undifferentiated pixel may be calculated by adding a corresponding pixel of the reference image used to create the differential image to the pixel of the decompressed differential image. The calculated undifferentiated pixels may then be placed in a position corresponding to the position of the pixel of the reference image used to calculate the undifferentiated pixel. The resultant image comprises an undifferentiated image.

According to another aspect of the invention, the systems and methods described herein may be configured to utilize the differential compression and decompression described above to create an efficient progressive image. To produce a progressive image, a first differential image may be created using a lowest-quality image of the progressive image stream of an original image as the initial reference image. For example, the lowest-quality image may be created using one or more existing compression methods and/or by downsizing the image. The lowest-quality image may be decompressed and resized to a pixel width and pixel height of the original image. Once decompressed, the lowest-quality image may be assigned as the variable reference image and placed at the beginning of the resulting progressive image stream. The differential image created using the lowest-quality image may then be compressed and appended to a progressive image stream. The compressed differential image may then be decompressed and used to produce an undifferentiated image of the original image. For example, for each pixel of the decompressed differential image, a corresponding pixel of the reference image (in this iteration, the lowest-quality image) may be added to the pixel of the decompressed differential image. The resulting undifferentiated pixels may then be placed in a position corresponding to the position of the pixel of the reference image used to calculate the undifferentiated pixel to produce the undifferentiated image. Once the undifferentiated image is produced, a determination is made as to whether the undifferentiated image meets the desired image quality. If the undifferentiated image meets a desired image quality, the progressive image stream may be completed with the undifferentiated image. If the undifferentiated image does not meet a desired image quality, these steps may be repeated using the resultant undifferentiated image as the reference image until the undifferentiated image produced meets the desired image quality.

These and other objects, features, and characteristics of the systems and/or methods disclosed herein, as well as the methods of operation and functions of the related elements of structure and the combination thereof, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

The present invention is illustrated by way of example and not limited in the accompanying figures in which like reference numerals indicate similar elements and in which:

FIG. 1 depicts a block diagram of an example of a system configured to create progressive image streams using differentially compressed images, according to one or more aspects described herein;

FIG. 2 depicts a flow diagram of an example of a method for producing a compressed differential image corresponding to a source image based on a source image and a reference image utilizing differential compression, according to one or more aspects described herein;

FIG. 3 depicts a flow diagram of an example of a method for utilizing differential decompression to decompress a differential image, according to one or more aspects described herein;

FIG. 4 depicts a flow diagram of an example of a method for creating a progressive image stream using differentially compressed images, according to one or more aspects described herein; and

FIG. 5 depicts a flow diagram of an example of a method for decoding and displaying a progressive image stream, according to one or more aspects described herein.

These drawings are provided for purposes of illustration only and merely depict typical or example embodiments. These drawings are provided to facilitate the reader's understanding and shall not be considered limiting of the breadth, scope, or applicability of the disclosure. For clarity and case of illustration, these drawings are not necessarily drawn to scale.

### DETAILED DESCRIPTION

Certain illustrative aspects of the systems and methods according to the present invention are described herein in connection with the following description and the accompanying figures. These aspects are indicative, however, of but a few of the various ways in which the principles of the invention may be employed and the present invention is intended to include all such aspects and their equivalents. Other advantages and novel features of the invention may become apparent from the following detailed description when considered in conjunction with the figures.

In the following detailed description, numerous specific details are set forth in order to provide a thorough understanding of the invention. In other instances, well known structures, interfaces, and processes have not been shown in detail in order not to unnecessarily obscure the invention. However, it will be apparent to one of ordinary skill in the art that those specific details disclosed herein need not be used to practice the invention and do not represent a limitation on the scope of the invention, except as recited in the claims. It is intended that no part of this specification be construed to effect a disavowal of any part of the full scope of the invention. Although certain embodiments of the present disclosure are described, these embodiments likewise are not intended to limit the full scope of the invention.

### Example System Architecture

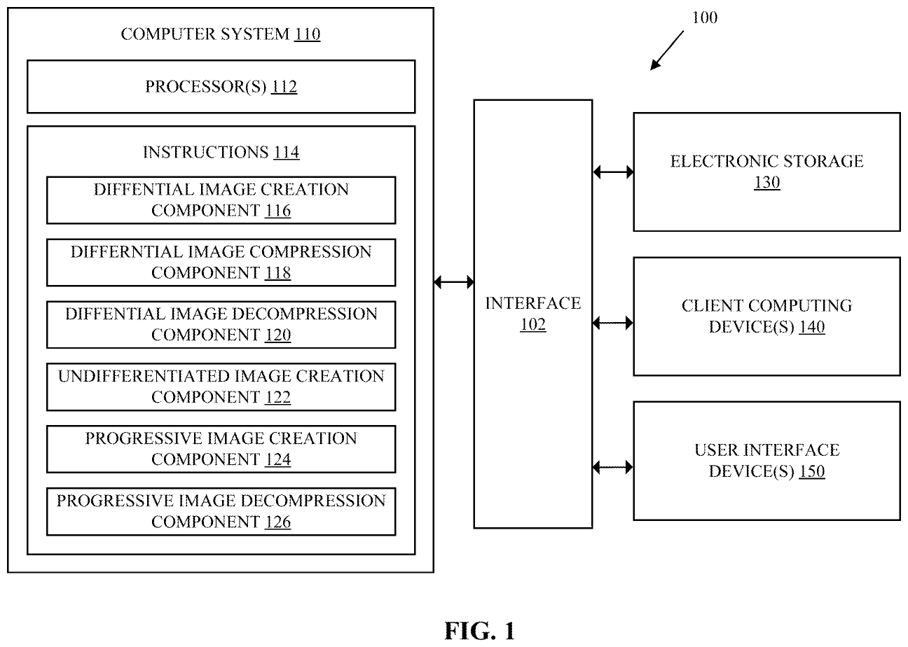

FIG. 1 illustrates an example of a system 100 for creating progressive image streams using differentially compressed images, according to one or more aspects described herein. In various implementations, system 100 may include one or more of interface 102, a computer system 110, electronic storage 130, client computing device(s) 140, and/or other components. In various implementations, computer system 110 may include one or more physical computer processors 112 (also interchangeably referred to herein as processor(s) 112, processor 112, or processors 112 for convenience), computer readable instructions 114, and/or one or more other components. In some implementations, system 100 may include one or more external resources, such as sources of information outside of system 100, external entities participating with system 100, and/or other resources. In various implementations, system 100 may be configured to receive input from or otherwise interact with one or more users via one or more client computing device(s) 140.

In various implementations, processor(s) 112 may be configured to provide information processing capabilities in system 100. As such, the processor(s) 112 may comprise one or more of a digital processor, an analog processor, a digital circuit designed to process information, a central processing unit, a graphics processing unit, a microcontroller, a microprocessor, a field programmable gate array (FPGA), an application specific integrated circuit (ASIC), a System on a Chip (SoC), and/or other mechanisms for electronically processing information. Processor(s) 112 may be configured to execute one or more computer readable instructions 114. Computer readable instructions 114 may include one or more computer program components. In various implementations, computer readable instructions 114 may include one or more of differential image creation component 116, differential image compression component 118, differential image decompression component 120, undifferentiated image creation component 122, progressive image creation component 124, progressive image decompression component 126, and/or other computer program components. As used herein, for convenience, the various computer readable instructions 114 will be described as performing an operation, when, in fact, the various instructions program the processor(s) 112 (and therefore system 100) to perform the operation.

Electronic storage 130 may include electronic storage media that electronically stores and/or transmits information. The electronic storage media of electronic storage 130 may be provided integrally (i.e., substantially nonremovable) with one or more components of system 100 and/or removable storage that is connectable to one or more components of system 100 via, for example, a port (e.g., USB port, a Firewire port, and/or other port) or a drive (e.g., a disk drive and/or other drive). Electronic storage 130 may include one or more of optically readable storage media (e.g., optical disks and/or other optically readable storage media), magnetically readable storage media (e.g., magnetic tape, magnetic hard drive, floppy drive, and/or other magnetically readable storage media), electrical charge-based storage media (e.g., EPROM, EEPROM, RAM, and/or other electrical charge-based storage media), solid-state storage media (e.g., flash drive and/or other solid-state storage media), and/or other electronically readable storage media. Electronic storage 130 may be a separate component within system 100, or electronic storage 130 may be provided integrally with one or more other components of system 100 (e.g., computer system 110 or processor 112). Although electronic storage 130 is shown in FIG. 1 as a single entity, this is for illustrative purposes only. In some implementations, electronic storage 130 may comprise a plurality of storage units. These storage units may be physically located within the same device, or electronic storage 130 may represent storage functionality of a plurality of devices operating in coordination.

Electronic storage 130 may store software algorithms, information determined by processor 112, information received remotely, and/or other information that enables system 100 to function properly. For example, electronic storage 130 may store information relating to one or more three-dimensional models, one or more textures, one or more existing compression methods (i.e., one or more existing compression algorithms) to be used to compress an image or texture, one or more existing decompression methods (i.e., one or more existing decompression algorithms) to be used to decompress a compressed image or texture, compressed image(s) themselves (such as a compressed integrated image or a compressed color-converted image), additional information associated with an image (such as a scale, a value map, a color conversion matrix that was used, a gamma correction that was used, and/or other information associated with an image), a well-known catalog of file headers that are likely to be encountered, and/or other information related to the systems and methods described herein.

Client computing device(s) 140 (also interchangeably referred to herein as client computing device 140, client computing devices 140, or one or more client computing devices 140) may be used by users of system 100 to interface with system 100. Client computing device(s) 140 may be configured as a server device (e.g., having one or more server blades, processors, etc.), a gaming console, a handheld gaming device, a personal computer (e.g., a desktop computer, a laptop computer, etc.), a smartphone, a tablet computing device, an Internet of Things (IoT) device, a wearable device, and/or other device that can be programmed to interface with computer system 110.

In various implementations, system 100 may include one or more user interface devices 150 connected to one or more components of system 100 via interface 102 to facilitate user interaction. For example, user interface device(s) 150 may include a monitor and/or other devices configured to display or otherwise provide information to the user. In various implementations, user interface device(s) 150 may include a keyboard, a pointing device such as a mouse or a trackball, and/or one or more other input devices to enable a user to provide input to computer system 110, electronic storage 130, and/or client computing devices 140 via interface 102.

### Differential Image Creation, Compression, and Decompression

In various implementations, differential image creation component 116 may be configured to produce a differential image corresponding to a source image based on the source image and a reference image. In various implementations, differential image creation component 116 may be configured to obtain a reference image (which may also be referred to herein as “RefImg”). A reference image may comprise an image of the same pixel size (i.e., same pixel width and pixel height) as a source image (which may also be referred to herein as an original image). The source image may comprise an image to be compressed. For example, in various implementations, the source image may comprise textures, images or maps associated with textures, and/or other images to be used when rendering three-dimensional models. For example, the image may comprise a normal map (e.g., represented as an RGB image) or any other type of texture/map, including a physically based rendering (PBR) map such as a base color map, a metal map, a roughness map, an emissive map, an ambient occlusion map, a diffuse map, a specular map, and/or one or more other similar types of maps. In various implementations, differential image creation component 116 may be configured to produce a differential image (which may also be referred to herein as “DiffImg”) that has a pixel width and pixel height that is the same as the pixel width and pixel height of the source image and reference image. For example, the pixels of the source image, the reference image, and the differential image correspond to one another if they have the same index vector or XIDX, YIDX coordinate within their respective image.

To generate the differential image, differential image creation component 116 may be configured to calculate, for a given pixel of the source image (which may also be referred to herein as “POrig”), a differential pixel (which may also be referred to herein as “PDiff”) by subtracting a corresponding pixel of the reference image (which may also be referred to herein as “PRef”) from the pixel of the source image (i.e., “PDiff=POrig−PRef”). In various implementations, differential image creation component 116 may be configured to perform a per-component subtraction of the RGB components of the pixel of the reference image from the RGB components of the pixel of the source image. For example, the R-component of the differential pixel may be calculated as “R(PDiff)=R(POrig)−R(PRef),” the G-component of the differential pixel may be calculated as “G(PDiff)=G(POrig)−G(PRef),” and the B-component of the differential pixel may be calculated as “B(PDiff)=B(POrig)−B(PRef).” In various implementations, differential image creation component 116 may be configured to place the differential pixel into a position which corresponds to the position of the pixel of the source image used to create the differential pixel. Differential image creation component 116 may be configured to perform the foregoing subtraction for each pixel of the source image to produce a differential image.

In some implementations, differential image creation component 116 may be configured to perform the per-component subtraction in a different color space. For example, differential image creation component 116 may be configured to perform the per-component subtraction in the YCbCr color space, the XYB color space, and/or one or more other different color spaces. As would be known to a person having ordinary skill in the art, the RGB color space uses the red-green-blue components of a color to display a color. Using these three components, any color can be displayed. The YCbCr color space and XYB color space are alternatives to the RGB color space. The YCbCr color space uses the “Y” or luma component (which defines the brightness or light intensity of the color), the “Cb” component (which is the blue component relative to the green component), and the “Cr” component (which is the red component relative to the green component. The XYB color space is a color space used, for example, by the JPEG XL file format that is specifically designed to model the behavior of rods and cones within the human eye. To perform subtraction in a different color space, differential image creation component 116 may be configured to apply a color space conversion matrix from RGB to the other color space prior to performing subtraction. In some implementations, differential image creation component 116 may be configured to perform gamma correction prior to applying the color space conversion. In some implementations, differential image creation component 116 may be configured to apply a color space conversion (and potentially apply gamma correction) as described in U.S. patent application Ser. No. 18/425,130, entitled “SYSTEMS AND METHODS FOR IMPROVING COMPRESSION OF NORMAL MAPS,” filed Jan. 29, 2024, the contents of which are hereby incorporated by reference herein in their entirety.

In some implementations, a modified version of an existing discrete cosine transform (DCT)-based compression method may be used by differential image compression component 118 to produce a compressed differential image. In the foregoing implementations, instead of subtracting images in the RGB domain or other color space domain, differential image creation component 116 may be configured to perform subtraction in a DCT domain. With DCT-based compression methods (which may include, for example, AVIF, WebP, and the JPEG family of compression methods), it may be common to convert image blocks (such as 8×8 blocks for JPEG, or any of power-of-two sizes between 4×4 and 256×256 for JPEG XL) into a corresponding matrix of DCT coefficients first, and then compress the DCT coefficients. To compress a differential image using a DCT-based compression method, DCT coefficients for the differential image may be calculated and compressed instead of the DCT coefficients for the original image. For example, differential image creation component 116 may be configured to first calculate DCT coefficients for a certain block of an original image (or for the whole image). These DCT coefficients may be referred to herein as “CoeffOrig.” Differential image creation component 116 may then be configured to calculate corresponding DCT coefficients for a reference image (which may also be referred to herein as “CoeffRef”). Differential image creation component 116 may then be configured to subtract the DCT coefficients of the reference image from the respective DCT coefficients for the original image to produce a DCT coefficient for each pixel of a differential image, (which may also be referred to herein as CoeffDiff):

$$CoeffDiff = CoeffOrig - CoeffRef$$

The calculated DCT coefficients for the differential image may then be compressed (e.g., by differential image compression component 118) to produce a compressed differential image.

In some implementations, differential image creation component 116 may be configured to perform subtraction in one or more other frequency domains (e.g., aside from DCT domain). For example, differential image creation component 116 may be configured to subtract Fourier coefficients instead of DCT coefficients.

In various implementations, differential image compression component 118 may be configured to compress a differential image. For example, differential image compression component 118 may be configured to compress a differential image corresponding to a source image based on the source image and reference image, as described herein with respect to differential image creation component 116. The compressed image may comprise a compressed differential image (which may also be referred to herein as “DiffImgC”). In various implementations, differential image compression component 118 may be configured to compress a differential image using one or more existing compression methods. In some implementations, differential image compression component 118 may be configured to apply one or more existing lossy compression methods to the image, such as the lossy compression methods used for the AVIF, WebP, HEIC, or WebP2 file formats or the lossy compression methods used for the JPEG family of file formats (e.g., JPEG, JPEG 2000, JPEG XR, and JPEG XL). In some implementations, differential image compression component 118 may be configured to apply one or more existing lossless compression methods to the image, such as the lossless compression methods used for the PNG, WebP, or WebP2 file formats or the lossless compression methods used for the JPEG family of file formats. These and other compression methods now known or future developed may be used with the systems and methods described herein.

In some implementations, differential image compression component 118 may be configured to compress a differential image by downsizing the differential image. For example, differential image compression component 118 may be configured to downsize the differential image by reducing pixel width and/or pixel height, using nearest-neighbor, bilinear, Lanczos, bicubical, and/or one or more other resizing methods, including methods ranging from methods associated with image scaling and noise reduction programs (e.g., waifu2x) to methods associated with Enhanced Super-Resolution Generative Adversarial Networks (ESRGAN).

In some implementations, differential image compression component 118 may be configured to use a modified compression method as an existing compression method. For example, differential image compression component 118 may be configured to use a compression method that first transforms an image into DCT coefficients (or other frequency-domain coefficients) and then encode the coefficients. For example, differential image compression component 118 may be configured to use non-image-specific compression methods such as entropy coding methods (such as, for example, Huffman coding, arithmetic coding, rANS, and tANS) and/or LZ-like methods (such as, for example, RLE, LZ77, and LZ78), or their combinations and/or standard compression methods (such as, for example, deflate, zstd, Izma, and/or similar compression methods).

In some implementations, differential image compression component 118 may be configured to compress a texture used for rendering a three-dimensional model while using another texture of the same three-dimensional model as a reference using one or more of the techniques described herein. In some implementations, a color space conversion may be applied to one or more both textures involved before creating a differential image and compressing the differential image. During decompression, an inverse color space conversion may be applied to the one or more textures. In some implementations, an occlusion-roughness-metallic (ORM) map may be used as a reference for compressing a diffuse texture such as an albedo or base color diffuse texture, or vice versa.

In various implementations, differential image decompression component 120 may be configured to decompress a compressed differential image. For example, differential image decompression component 120 may be configured to decompress the compressed differential image using an existing decompression method. For example, differential image decompression component 120 may be configured to decompress the compressed differential image with a decompression method that is complimentary to a compression method used to compress the differential image.

In various implementations, undifferentiated image creation component 122 may be configured to use the reference image that was used to produce the differential image to calculate an undifferentiated image. The resultant image may comprise an undifferentiated image. For example, undifferentiated image creation component 122 may be configured to calculate, for a given pixel of the decompressed differential image (or “PDiff”), an undifferentiated pixel (which may also be referred to herein as “PUndiff”) by adding a corresponding pixel of the reference image (or “PRef”) to the pixel of the decompressed differential image (i.e., “PUndiff=PRef+PDiff”). In various implementations, undifferentiated image creation component 122 may be configured to perform a per-component addition of the RGB components of the pixel of the reference image to the RGB components of the pixel of the decompressed differential image. For example, the R-component of the undifferentiated pixel may be calculated as “R(PUndiff)=R(PRcf)+R(PDiff),” the G-component of the undifferentiated pixel may be calculated as “G(PUndiff)=G(PRef)+G(PDiff),” and the B-component of the undifferentiated pixel may be calculated as “B(PUndiff)=B(PRef)+B(PDiff).” In various implementations, undifferentiated image creation component 122 may be configured to place the undifferentiated pixel into the undifferentiated image at a position of the corresponding pixel of the reference image. Undifferentiated image creation component 122 may be configured to perform the foregoing addition for each pixel of the decompressed differential image to produce the undifferentiated image.

In some implementations, undifferentiated image creation component 122 may be configured to convert a color-converted image back into the original image after performing the addition described herein. For example, as described herein, a color space conversion matrix may be applied to convert an image from RGB to another color space prior to performing the subtraction described herein to create the differential image. In implementations in which the source image was converted from RGB to another color space prior to performing the subtraction to create the differential image, undifferentiated image creation component 122 may be configured to apply an inverse color space conversion matrix to convert the image back to RGB from another color space (e.g., YCbCr or XYB) after performing the addition described herein. In some implementations, undifferentiated image creation component 122 may be configured to perform inverse gamma correction prior to applying the color space conversion. In some implementations, undifferentiated image creation component 122 may be configured to apply an inverse color space conversion (and potentially apply inverse gamma correction) as described in U.S. patent application Ser. No. 18/425,130, entitled “SYSTEMS AND METHODS FOR IMPROVING COMPRESSION OF NORMAL MAPS,” filed Jan. 29, 2024, the contents of which are hereby incorporated by reference herein in their entirety.

In some implementations, differential images may be produced by subtracting DCT coefficients of a reference image from the respective DCT coefficients for the original image to produce a DCT coefficient for every pixel of a differential image (as described herein with respect to differential image creation component 116). In the foregoing implementations, differential image decompression component 120 may be configured to decompress such a differential image up to the point when DCT coefficients are obtained. Undifferentiated image creation component 122 may then be configured to calculate corresponding DCT coefficients for a reference image. Undifferentiated image creation component 122 may then be configured to calculate, for each of the DCT coefficients, a coefficient of the original image:

$$CoeffOrig = CoeffDiff + CoeffRef$$

Differential image decompression component 120 may then be configured to decompress the calculated DCT coefficients for the original image to produce an undifferentiated image that corresponds to the original image.

### Progressive Image Creation

In various implementations, progressive image creation component 124 may be configured to create a progressive image stream. As described herein, a progressive image stream may comprise a series or sequence of images of gradually-increasing quality. In various implementations, progressive image creation component 124 may be configured to utilize differential compression and decompression to produce a progressive image stream. In some implementations, progressive image creation component 124 may be configured to use the result of the file or stream to encode textures for a 3D model. In various implementations, a progressive image stream created using the technique(s) described herein may represent textures for different levels of detail (LODs) for a single three-dimensional model. For example, the progressive image creation component 124 may be configured to use the result of the file or stream to encode LODs for three-dimensional models, including base or diffuse textures, normal maps, metallic maps, roughness maps, and/or one or more other similar types of texture maps. In various implementations, progressive image creation component 124 may be configured to obtain a width and height of an original image and encode the width and height of the original image to the stream.

In various implementations, progressive image creation component 124 may be configured to create a lowest-quality image for the progressive image stream. For example, to create the lowest-quality image, progressive image creation component 124 may be configured to use one or more existing compression methods and/or downsize the image (as described herein with respect to the differential image compression component 118). In various implementations, the lowest-quality image may comprise the smallest image in the progressive image stream. In some implementations, progressive image creation component 124 may be configured to decompress the lowest-quality image. For example, progressive image creation component 124 may be configured to decompress the lowest-quality image into an RGB raster form. The decompressed (or decoded) lowest-quality image may be used as an initial reference image. In various implementations, progressive image creation component 124 may be configured to place the decoded lowest-quality image at the beginning of the resulting file or stream.

In various implementations, if the decoded lowest-quality image has a smaller pixel width or pixel height compared to the original image, progressive image creation component 124 may be configured to resize the lowest-quality image back to the (usually larger) original pixel width and pixel height. For example, progressive image creation component 124 may be configured to use nearest-neighbor, bilinear, and/or one or more other resizing methods to resize the lowest-quality image back to the pixel width and pixel height of the original image. The resultant image may have exactly the same pixel width and pixel height as the original image In various implementations, progressive image creation component 124 may be configured to assign this resulting image as a variable reference image. Accordingly, progressive image creation component 124 may be configured to first use the lowest-quality image as the reference image. As used herein, the reference image (or “RefImg”) may be considered to be an approximation of the original image that a decompressor (e.g., differential image decompression component 120 or progressive image decompression component 126) can obtain from the stream at any current point in the stream. For example, during decoding, when a given point in a file/stream is reached, the reference image may be calculated and displayed, or otherwise utilized as described herein.

In various implementations, progressive image creation component 124 may be configured to produce a differential image (or “DiffImg”) corresponding to the original image based on the original image and a reference image. As described herein, the reference image may comprise the lowest-quality image. For example, to generate the differential image, progressive image creation component 124 may be configured to calculate, for each pixel of the original image, a differential pixel (or “PDiff”) by subtracting a corresponding pixel of the lowest-quality image from the pixel of the original image (or “POrig”) and place each differential pixel into a position which corresponds to the position of the pixel of the original image used to create the differential pixel (as described herein with respect to the differential image creation component 116). In some implementations, progressive image creation component 124 may be configured to use different differentiation methods (or subtraction methods) for different images in a progressive image stream.

In various implementations, progressive image creation component 124 may be configured to compress a differential image. For example, progressive image creation component 124 may be configured to compress the differential image corresponding to an original image and produced based on the original image and a reference image. In various implementations, differential image compression component 118 may be configured to compress a differential image using one or more existing compression methods and/or by downsizing the differential image, as described herein with respect to differential image compression component 118. In some implementations, this compression may use higher pixel size and/or higher quality than an image previously placed in the resulting stream. In various implementations, progressive image creation component 124 may be configured to append the compressed differential image (or “DiffImgC”) to the file or stream. In some implementations, progressive image creation component 124 may be configured to use a non-progressive encoding (or non-progressive mode for progressive-supporting encoding) for one or more first differential images and use a progressive mode of progressive encoding for the last differential image.

In some implementations, progressive image creation component 124 may be configured to use one compression method for one or more first differential images and a different compression method for one or more later differential images. For example, progressive image creation component 124 may be configured to use a method used for the AVIF file format for one or more first images and method(s) used for the JPEG family of file formats (such as JPEG, JPEG 2000, JPEG XR, JPEG XL) for the last image. In various implementations, a person having ordinary skill in the art would appreciate that this approach may provide a mix-and-match capability. For example, progressive image creation component 124 may be configured to use a lowest-quality image first, then apply one or more differential non-progressive images using the method described herein, and then for the last differential image, use an existing progressive encoding method.

In various implementations, progressive image creation component 124 may be configured to use one or more existing compression methods for differential images in a progressive image stream. For example, in some implementations, progressive image creation component 124 may be configured to use the same existing compression method for all differential images in a progressive image stream. In other implementations, progressive image creation component 124 may be configured to use different existing compression methods for different differential images in a progressive image stream. In implementations in which different existing compression methods are used for different differential images in the progressive image stream, the progressive image stream may be referred to as a “heterogeneous progressive image stream.”

When placing an encoded image (e.g., the compressed differential image) into the file or stream, progressive image creation component 124 may be configured to compress file headers for the encoded images. For example, in certain cases, especially for lower bits per pixel (bpp) rates, file headers may take up to 50% of the total size. In various implementations, progressive image creation component 124 may be configured to compress the file header of an encoded image using a priori knowledge of what the file header will likely look like. For example, progressive image creation component 124 may be configured to access a well-known catalog of file headers that are likely to be encountered. In some implementations, this catalog of file headers that are likely to be encountered may be pre-shared with both compressors (or components described herein configured to compress images) and decompressors (or components described herein configured to decompress images) of system 100. If a corresponding file header listed in this catalog of file headers is encountered, progressive image creation component 124 may be configured to replace the file header with an identifier (or ID) of the file header in the catalog. In some embodiments, progressive image creation component 124 may be configured to use an ID of the header and apply a few “patched bytes” on top of this pre-defined header. In various implementations, progressive image creation component 124 may be configured to use a differential compression method, such as Courgette, bsdiff, or similar compression methods. For example, progressive image creation component 124 may be configured to use a set of pre-defined headers (known to both compression and decompression components) as a “base” for differential compression.

In some implementations, progressive image creation component 124 may be configured to use “prepopulated compression” to compress a file header. For example, progressive image creation component 124 may be configured to create a pre-defined file consisting of one or more commonly encountered file headers. In some implementations, progressive image creation component 124 may be configured to compress a pre-defined file first and then optionally execute a “flush( )” command to make sure that all the compressed stream of already-compressed data is emitted. In various implementations, progressive image creation component 124 may then be configured to discard all data from the compressed stream up to this point. In various implementations, progressive image creation component 124 may then be configured to compress the headers of the file, wherein the compressed data may only represent the part of the stream which is emitted after the “flush( )” command is executed. The foregoing compression technique may allow data to be injected from the pre-defined file so that, for example, an LZ77-based method (such as deflate or LZHL) can refer to this data. In various implementations, progressive image creation component 124 may be configured to perform the foregoing compression (e.g., using a ZLIB or LZHL) using one or more techniques described in “An Algorithm for Online Data Compression” by Sergey Ignatchenko, which was published in C/C++ Users Journal, Vol. 6, No. 10 in October 1998, the contents of which are herein incorporated by reference in their entirety. When a file with a file header compressed as described herein is decompressed (e.g., by differential image decompression component 120 or progressive image decompression component 126), the compressed stream of predefined file may be decompressed first. A flush( ) command may then optionally be executed before all the data up to that point is decompressed. The compressed data may then be decompressed, wherein the result is the data emitted after discarding.

In some implementations, progressive image creation component 124 may be configured to compress a file header using a compression method that supports a pre-populated dictionary. For example, progressive image creation component 124 may be configured to compress a file header using method(s) associated with Zstandard (or zstd) compression. For example, progressive image creation component 124 may be configured to use one or more pre-defined headers as part(s) of the pre-populated dictionary or a dictionary obtained as a result of training.

In various implementations, progressive image creation component 124 may be configured to decompress a compressed differential image, for example, as described herein with respect to differential image decompression component 120. For example, progressive image creation component 124 may be configured to decompress the compressed differential image using an existing decompression method. The resultant image may comprise a decompressed differential image that differs from the differential image used to create the compressed differential image prior to it being compressed (e.g., as described herein with respect to differential image creation component 116) if compression is lossy. In various implementations, progressive image creation component 124 may be configured to upsize the decompressed differential image so that the resultant image has the same pixel width and pixel height as the original image. In various implementations, progressive image creation component 124 may be configured to use the reference image that was used to produce the differential image to calculate an undifferentiated image. For example, progressive image creation component 124 may be configured to calculate, for a given pixel of the decompressed (and upsized) differential image, an undifferentiated pixel by adding a corresponding pixel of the reference image to the pixel of the decompressed differential image (as described herein with respect to the undifferentiated image creation component 122). After this step is performed for each pixel of the decompressed differential image, progressive image creation component 124 may be configured to assign the resultant undifferentiated image as the variable reference image. Accordingly, progressive image creation component 124 may be configured to now use this undifferentiated image as the reference image. During decoding, when a given point in the file/stream is reached, a corresponding reference image may be calculated and displayed.

If the undifferentiated image meets a desired image quality, progressive image creation component 124 may be configured to complete the progressive image stream with the undifferentiated image. If the undifferentiated image does not meet a desired image quality, progressive image creation component 124 may be configured to repeat this process (e.g., produce another differential image using the undifferentiated image as a reference image, compressing this differential image, and decompressing this differential image using the prior differential image as a reference image to produce another undifferentiated image). In various implementations, progressive image creation component 124 may be configured to repeat this process until the undifferentiated image meets a desired image quality in order to produce the progressive image stream.

In some implementations, a progressive image may be implemented based on inter-frame compression (and/or inter-frame prediction) of a video compression method (such as AV1, VP8, VP9, HEVC, AVC, Theora, or one or more other compression methods). For example, progressive image creation component 124 may be configured to use an existing video compression method and create a pseudo-video. Progressive image creation component 124 may then be configured to feed the first image into the video compression method as the first frame, then feed the second image to the video codec as the second frame of the pseudo-video, and continue this process as necessary. To decompress, the video may be rendered using appropriate frames of the video. In some implementations, progressive image creation component 124 may be configured to feed a reference image as the first frame of the pseudo-video and use the image to be compressed as the second frame of the pseudo video. In some implementations, progressive image creation component 124 may be configured to add duplicate frames (either within the stream or at the end) to the pseudo-video when encoding it. This may improve the image quality for the images.

In various implementations, progressive image creation component 124 may be configured to create a pseudo-video that encodes images-with-increasing-quality as subsequent frames of a video. In some implementations, progressive image creation component 124 may use existing video compression methods including an intra-frame and/or an inter-frame compression method. In various implementations, progressive image creation component 124 may need both intra-frame and inter-frame compression methods to achieve maximum compression efficiency out of a sequence that includes similar images. In some implementations, an existing video compression method, such as H.264 or AVIF, may be used to compress the pseudo-video.

### Progressive Image Decompression

In various implementations, progressive image decompression component 126 may be configured to decode and display a progressive image stream. In various implementations, progressive image decompression component 126 may be configured to obtain a width and height of an initial image from the stream and assign the width and height of the initial image to the stream. In various implementations, progressive image decompression component 126 may be configured to start with the initial image from the stream by upscaling the initial image (if necessary) and assigning the resultant initial image as the initial progressive reference image.

In various implementations, progressive image decompression component 126 may be configured to take a next image from the stream, upsize that next image to the same pixel width and pixel height as the initial image (if necessary), and calculate an undifferentiated image of the next image from the stream using the initial image as a progressive reference image. For example, progressive image decompression component 126 may be configured to calculate, for a given pixel of the next image from the stream, an undifferentiated pixel by adding a corresponding pixel of the reference image (i.e., the initial image) to the pixel of the next image from the stream (as described herein with respect to the undifferentiated image creation component 122). After this step is performed for each pixel of the next image from the stream, progressive image decompression component 126 may be configured to assign the resultant undifferentiated image as the progressive reference image. Accordingly, progressive image decompression component 126 may be configured to now use this undifferentiated image produced based on the next image from the stream as the next progressive reference image. Progressive image decompression component 126 may be configured to repeat this process (i.e., using the undifferentiated image produced based on the previous image in the stream) for each subsequent image from the stream.

### Example Flowcharts of Processes

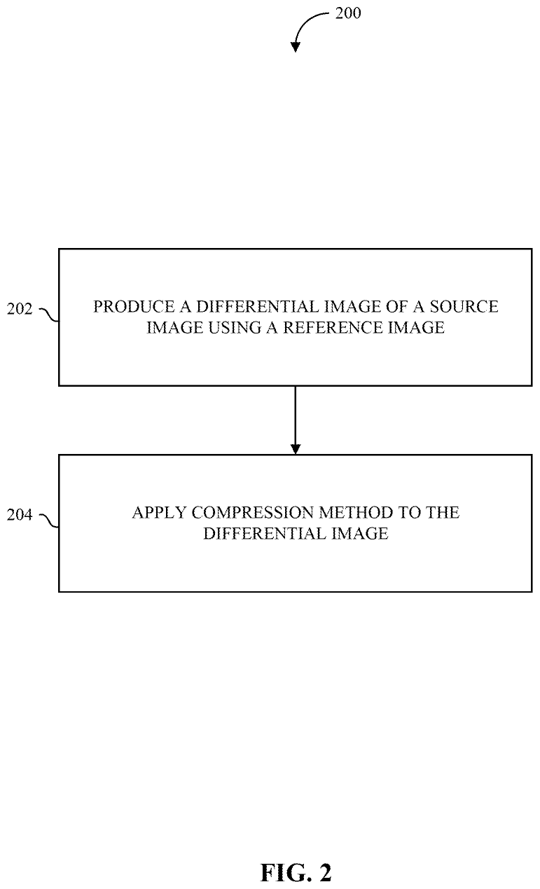

FIG. 2 illustrates an example of a process 200 for producing a compressed differential image corresponding to a source image based on a source image and a reference image utilizing differential compression, according to one or more aspects described herein. The operations of process 200 presented below are intended to be illustrative and, as such, should not be viewed as limiting. In some implementations, process 200 may be accomplished with one or more additional operations not described, and/or without one or more of the operations discussed. In some implementations, two or more of the operations of process 200 may occur substantially simultaneously. The described operations may be accomplished using some or all of the system components described in detail above.

In an operation 202, process 200 may include producing a differential image of a source image using a reference image. In various implementations, the image may comprise a normal map (e.g., represented as an RGB image) or any other type of texture/map, including a physically based rendering (PBR) map such as a base color map, a metal map, a roughness map, an emissive map, an ambient occlusion map, a diffuse map, a specular map, and/or one or more other similar types of maps. In various implementations, the reference image may comprise an image of the same pixel size (i.e., same pixel width and pixel height) as the source image. In an exemplary implementation, the source image may comprise a texture used to render a three-dimensional model, and the reference image may comprise another texture used to render the three-dimensional model. In some implementations, operation 202 may be performed by a processor component the same as or similar to differential image creation component 116 (shown in FIG. 1 and described herein).

In various implementations, producing the differential image may comprise calculating a differential pixel for each pixel of a source image. For example, for each pixel of the source image, a differential pixel may be calculated by subtracting a corresponding pixel of a reference image from the pixel of the source image. In various implementations, subtracting the corresponding pixel of the reference image from the pixel of the source image may comprise a per-component subtraction of RGB components of the corresponding pixel of the reference image from RGB components of the pixel of the source image. To produce the differential image, the calculated differential pixels may be placed in a position corresponding to the position of the pixel of the source image used to calculate the differential pixel.

In some implementations, the per-component subtraction of the reference image from the source image may be performed in a color space other than RGB. For example, to do so, a color space conversion may be applied to each pixel of the source image prior to subtracting the corresponding pixel of the reference image. In some implementations, gamma correction may also be performed prior to applying the color space conversion. In some implementations, the differential image may be calculated in a frequency domain. For example, in some implementations, a DCT coefficient may be calculated for each pixel of the source image and each pixel of the reference image. When subtracting the reference image from the source image, the DCT coefficient for each pixel of the reference image may be subtracted from the DCT coefficient for the corresponding pixel of the source image.

In an operation 204, process 200 may include compressing a differential image. For example, to compress the differential image, an existing compression method may be applied to the differential image. In various implementations, the differential image may be compressed using a compression method associated with an existing file format. For example, the differential image may be compressed by applying a compression method associated with the AVIF, JPEF, or JPEG XL file formats. In some implementations, compressing the differential image may comprise compressing DCT coefficients calculated for each pixel of the differential image. In some implementations, operation 204 may be performed by a processor component the same as or similar to differential image compression component 118 (shown in FIG. 1 and described herein).

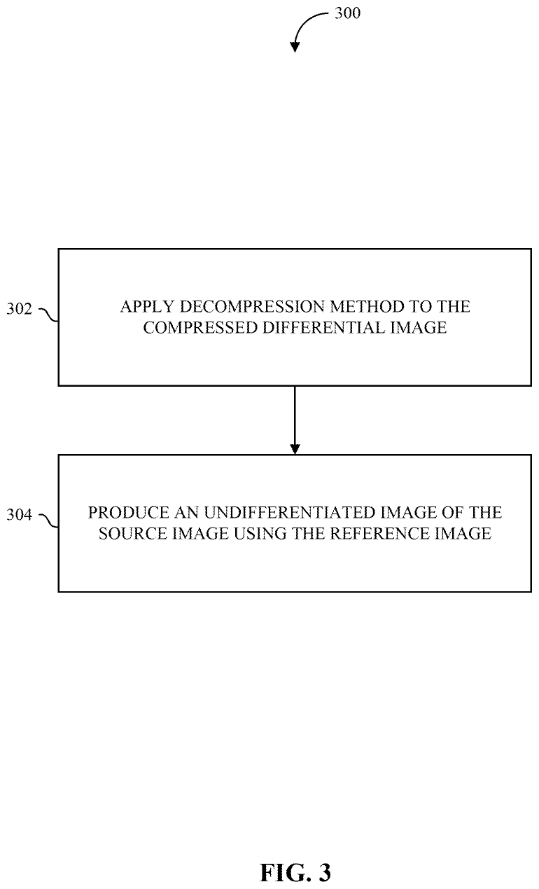

FIG. 3 illustrates an example of a process 300 for utilizing differential decompression to decompress a differential image, according to one or more aspects described herein. The operations of process 300 presented below are intended to be illustrative and, as such, should not be viewed as limiting. In some implementations, process 300 may be accomplished with one or more additional operations not described, and/or without one or more of the operations discussed. In some implementations, two or more of the operations of process 300 may occur substantially simultaneously. The described operations may be accomplished using some or all of the system components described in detail above.

In an operation 302, process 300 may include decompressing a compressed differential image. For example, to decompress the compressed differential image, an existing decompression method may be applied to the compressed differential image. The existing decompression method may comprise a decompression method that is complementary to a compression method used to compress the differential image. For example, the decompression method may comprise a method complementary to a compression method associated with an existing file format (such as AVIF, JPEF, JPEG XL, and/or one or more other existing file formats). In some implementations, operation 302 may be performed by a processor component the same as or similar to differential image decompression component 120 (shown in FIG. 1 and described herein).

In an operation 304, process 300 may include producing an undifferentiated image of the source image using a reference image. The undifferentiated image may comprise a decompressed version of the source image. In various implementations, producing the undifferentiated image may comprise calculating an undifferentiated pixel for each pixel of the decompressed differential image. For example, for each pixel of the decompressed differential image, an undifferentiated pixel may be calculated by adding a corresponding pixel of a reference image to the pixel of the decompressed differential image. In various implementations, the reference image may comprise the same image used to create the differential image in operation 202. In various implementations, adding the corresponding pixel of the reference image to the pixel of the decompressed differential image may comprise a per-component addition of RGB components of the corresponding pixel of the reference image to RGB components of the pixel of the decompressed differential image. To produce the undifferentiated image, the calculated undifferentiated pixels may be placed in a position corresponding to the position of the pixel of the reference image used to calculate the undifferentiated pixel. In some implementations, operation 304 may be performed by a processor component the same as or similar to undifferentiated image creation component 122 (shown in FIG. 1 and described herein).

In some implementations, after the per-component addition of the reference image to the decompressed differential image, an inverse color space conversion may be applied to each pixel to convert the resultant image to the color space of the source image. In some implementations, inverse gamma correction may also be performed prior to applying the inverse color space conversion. In some implementations, the undifferentiated image may be calculated in a frequency domain. For example, in some implementations, the differential image may be decompressed up to a point when DCT coefficients for the compressed differential image are obtained. At that point, a DCT coefficient may be calculated for each pixel of the reference image. The DCT coefficient for each pixel of the reference image may then be added to the DCT coefficient for the corresponding pixel of the compressed differential image to calculate coefficients for each pixel of an original image. The DCT coefficients calculated for each pixel of the original image may then be decompressed to produce an undifferentiated image that corresponds to the original image.

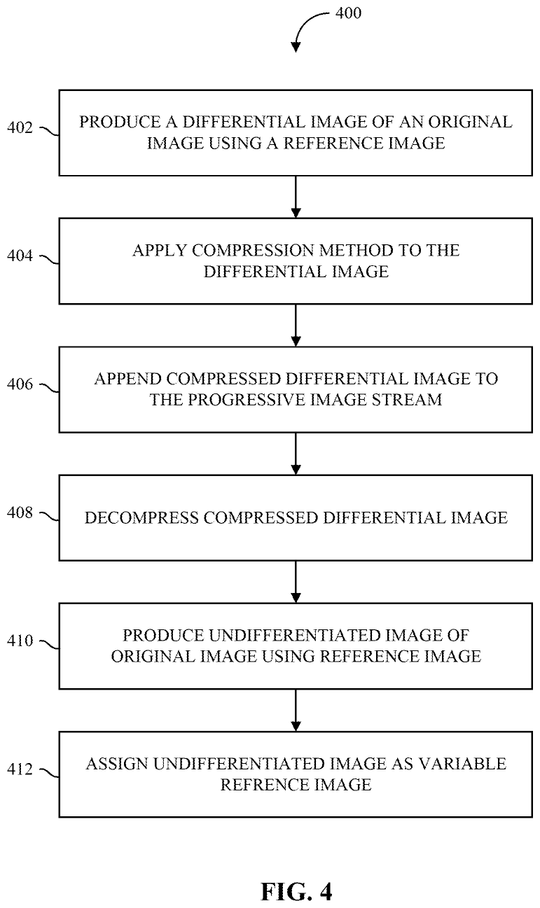

FIG. 4 illustrates an example of a process 400 for creating a progressive image stream using differentially compressed images, according to one or more aspects described herein. The operations of process 400 presented below are intended to be illustrative and, as such, should not be viewed as limiting. In some implementations, process 400 may be accomplished with one or more additional operations not described, and/or without one or more of the operations discussed. In some implementations, two or more of the operations of process 400 may occur substantially simultaneously. The described operations may be accomplished using some or all of the system components described in detail above.

In an operation 402, process 400 may include producing a differential image of an original image using a reference image. To produce a differential image using a reference image, a differential pixel for each pixel of the original image may be calculated. For example, for each pixel of the source image, a differential pixel may be calculated by subtracting a corresponding pixel of a reference image from the pixel of the source image. In various implementations, subtracting the corresponding pixel of the reference image from the pixel of the source image may comprise a per-component subtraction of RGB components of the corresponding pixel of the reference image from RGB components of the pixel of the source image. To produce the differential image, the calculated differential pixels may be placed in a position corresponding to the position of the pixel of the source image used to calculate the differential pixel. In some implementations, operation 402 may be performed by a processor component the same as or similar to progressive image creation component 124 (shown in FIG. 1 and described herein).

Initially, the differential image may be created using a lowest-quality image of the progressive image stream of an original image as the initial reference image, as described herein. For example, the lowest-quality image may be created using one or more existing compression methods and/or by downsizing the image. In various implementations, the lowest-quality image may comprise the smallest image in the progressive image stream. The lowest-quality image may be decompressed and resized to a pixel width and pixel height of the original image. Once decompressed, the lowest-quality image may be assigned as a variable reference image and placed at the beginning of the resulting progressive image stream. As used herein, the reference image may be considered to be an approximation of the original image that a decompressor can obtain from the stream at any current point in the stream. For example, during decoding, when a given point in a file/stream is reached, the reference image may be calculated and displayed, or otherwise utilized as described herein.

In an operation 404, process 400 may include applying a compression method to the differential image. In various implementations, the differential image may be compressed using a compression method associated with an existing file format. For example, the differential image may be compressed by applying a compression method associated with the AVIF, JPEF, or JPEG XL file formats. In some implementations, different compression methods may be used to compress different images within a single progressive image stream. For example, a first compression method may be used to compress one or more images within a progressive image stream and a second compression method may be used to compress one or more other images within the same progressive image stream. In an example implementation, a method associated with the AVIF file format may be used to compress at least one image within a progressive image stream and a method associated with the JPEG XL file format may be used to compress at least one other image within a progressive image stream. In some implementations, operation 404 may be performed by a processor component the same as or similar to progressive image creation component 124 (shown in FIG. 1 and described herein).

In an operation 406, process 400 may include appending a compressed differential image to a progressive image stream. In some implementations, operation 406 may be performed by a processor component the same as or similar to progressive image creation component 124 (shown in FIG. 1 and described herein).

In an operation 408, process 400 may include decompressing a compressed differential image. For example, to decompress the compressed differential image, an existing decompression method may be applied to the compressed differential image. The existing decompression method may comprise a decompression method that is complementary to a compression method used to compress the differential image. For example, the decompression method may comprise a method complementary to a compression method associated with an existing file format (such as AVIF, JPEF, JPEG XL, and/or one or more other existing file formats). In some implementations, operation 408 may be performed by a processor component the same as or similar to progressive image creation component 124 (shown in FIG. 1 and described herein).

In an operation 410, process 400 may include producing an undifferentiated image of an original image using a reference image. As described herein, the lowest-quality image may initially be assigned as the variable reference image and used to calculate a first undifferentiated image. In various implementations, producing the undifferentiated image may comprise calculating an undifferentiated pixel for each pixel of the decompressed differential image. For example, for each pixel of the decompressed differential image, an undifferentiated pixel may be calculated by adding a corresponding pixel of a reference image to the pixel of the decompressed differential image. In various implementations, the reference image may comprise the same image used to create the differential image in operation 402. In various implementations, adding the corresponding pixel of the reference image to the pixel of the decompressed differential image may comprise a per-component addition of RGB components of the corresponding pixel of the reference image to RGB components of the pixel of the decompressed differential image. To produce the undifferentiated image, the calculated undifferentiated pixels may be placed in a position corresponding to the position of the pixel of the reference image used to calculate the undifferentiated pixel. In some implementations, operation 410 may be performed by a processor component the same as or similar to progressive image creation component 124 (shown in FIG. 1 and described herein).

In an operation 412, process 400 may include assigning the undifferentiated image as the variable reference image. As described herein, the variable reference image is calculated and displayed during decoding when a corresponding point in the progressive image stream is reached. In some implementations, operation 412 may be performed by a processor component the same as or similar to progressive image creation component 124 (shown in FIG. 1 and described herein).

In various implementations, after an undifferentiated image of an original image produced using a lowest-quality image as a reference frame (as described with respect to operation 410) is assigned as the variable reference frame (as described with respect to operation 412), process 400 may further include determining whether the undifferentiated image mects a desired image quality. If the undifferentiated image meets a desired image quality, the progressive image stream may be completed with the undifferentiated image. If the undifferentiated image does not meet a desired image quality, process 400 may be repeated using the resultant undifferentiated image as the reference image until the undifferentiated image produced meets the desired image quality.

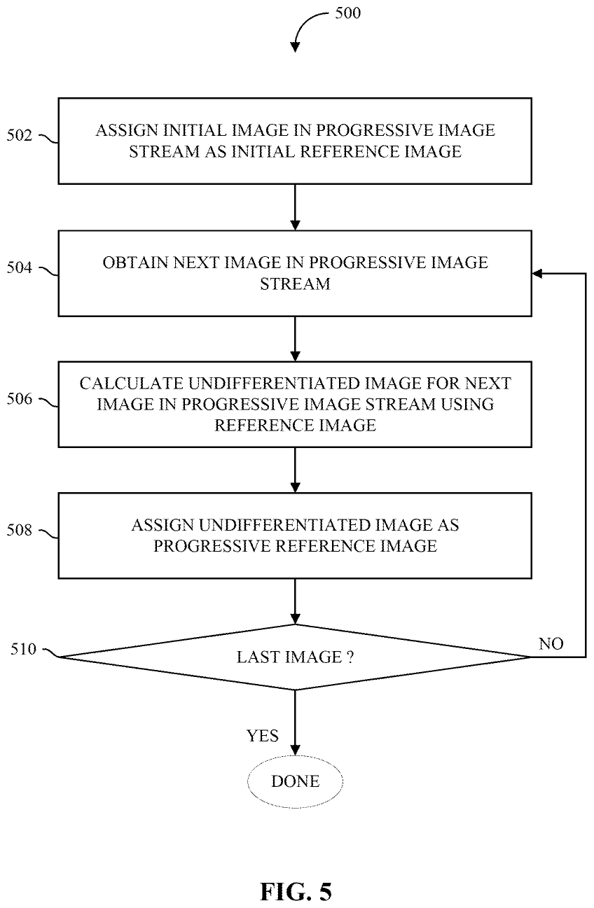

FIG. 5 illustrates an example of a process 500 for decoding and displaying a progressive image stream, according to one or more aspects described herein. The operations of process 500 presented below are intended to be illustrative and, as such, should not be viewed as limiting. In some implementations, process 500 may be accomplished with one or more additional operations not described, and/or without one or more of the operations discussed. In some implementations, two or more of the operations of process 500 may occur substantially simultaneously. The described operations may be accomplished using some or all of the system components described in detail above.

In an operation 502, process 500 may include assigning an initial image of a progressive image stream as an initial reference image. In various implementations, an initial image for a progressive image stream may be obtained. In some implementations, the initial image may be upscaled, if necessary. In various implementations, the pixel width and pixel height of the initial image for the progressive image stream may be assigned to the stream itself. In some implementations, operation 502 may be performed by a processor component the same as or similar to progressive image decompression component 126 (shown in FIG. 1 and described herein).

In an operation 504, process 500 may include obtaining a next in the progressive image stream. In various implementations, the next image from the stream may be upsized (if necessary) so that its pixel width and pixel height is the same as the initial image. In some implementations, operation 504 may be performed by a processor component the same as or similar to progressive image decompression component 126 (shown in FIG. 1 and described herein).

In an operation 506, process 500 may include calculating an undifferentiated image for the next image of the progressive image stream using the initial image as an initial reference image. For example, for a given pixel of the next image from the stream, an undifferentiated pixel may be calculated by adding a corresponding pixel of the reference image (i.e., the initial image) to the pixel of the next image from the stream, utilizing one or more of the techniques described herein. In some implementations, operation 506 may be performed by a processor component the same as or similar to progressive image decompression component 126 (shown in FIG. 1 and described herein).

In an operation 508, process 500 may include assigning the undifferentiated image calculated as the progressive reference image. In some implementations, operation 508 may be performed by a processor component the same as or similar to progressive image decompression component 126 (shown in FIG. 1 and described herein).

In an operation 510, process 500 may include determining whether previously processed image is the last image of a progressive image stream. If the image is not the last image of the progressive image stream, process 500 may return to operation 504 and obtain a next in the progressive image stream. In various implementations, the next image from the stream may be upsized (if necessary) so that its pixel width and pixel height is the same as the initial image. In some implementations, operation 510 may be performed by a processor component the same as or similar to progressive image decompression component 126 (shown in FIG. 1 and described herein).

Operation 504, operation 506, operation 508, and operation 510 may be repeated for each subsequent image in the progressive image stream until reaching the last image in the progressive image stream. For the first image after the image assigned as the initial reference image, an undifferentiated image is calculated using the initial reference image. For each subsequent image in the progressive image stream, an undifferentiated image is calculated based on the previous image in the stream (i.e., which is assigned as the progressive reference image), and then that undifferentiated image is assigned as the progressive reference image for the next image in the stream. These steps may repeat until an undifferentiated image has been calculated for the last image in the progressive image steam. The undifferentiated image calculated for the last image in the progressive image stream may comprise the final image displayed for the progressive image stream.

The methods disclosed herein comprise one or more steps or actions for achieving the described method. The method steps and/or actions may be interchanged with one another without departing from the scope of the present invention. In other words, unless a specific order of steps or actions is required for proper operation of the embodiment, the order and/or use of specific steps and/or actions may be modified without departing from the scope of the present invention.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a tangible computer readable storage medium may include read only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific exemplary aspects and implementations of the disclosure, and performing certain actions.

The various illustrative logical blocks, modules, circuits, and algorithm steps described in connection with the embodiments disclosed herein may be implemented as electronic hardware, computer software, or combinations of both. To illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality can be implemented in varying ways for each particular application—such as by using any combination of digital processors, analog processors, digital circuits designed to process information, central processing units, graphics processing units, microcontrollers, microprocessors, field programmable gate arrays (FPGAs), application specific integrated circuits (ASICs), a System on a Chip (SoC), and/or other mechanisms for electronically processing information—but such implementation decisions should not be interpreted as causing a departure from the scope of the present invention.

The description of the functionality provided by the different computer-readable instructions described herein is for illustrative purposes, and is not intended to be limiting, as any of instructions may provide more or less functionality than is described. For example, one or more of the instructions may be eliminated, and some or all of its functionality may be provided by other ones of the instructions. As another example, processor(s) 112 may be programmed by one or more additional instructions that may perform some or all of the functionality attributed herein to one of the computer-readable instructions.

The various instructions described herein may be stored in electronic storage, which may comprise random access memory (RAM), read only memory (ROM), and/or other memory. In some implementations, the various instructions described herein may be stored in electronic storage of one or more components of system 100 and/or accessible via a network (e.g., via the Internet, cloud storage, and/or one or more other networks). The electronic storage may store the computer program instructions (e.g., the aforementioned instructions) to be executed by processor(s) 112 as well as data that may be manipulated by processor(s) 112. The electronic storage may comprise floppy disks, hard disks, optical disks, tapes, or other storage media for storing computer-executable instructions and/or data.

Although illustrated in FIG. 1 as a single component, computer system 110 and client computing device(s) 140 may each include a plurality of individual components (e.g., computer devices) each programmed with at least some of the functions described herein. In this manner, some components of computer system 110 and/or associated client computing device(s) may perform some functions while other components may perform other functions, as would be appreciated. Furthermore, it should be appreciated that although the various instructions are illustrated in FIG. 1 as being co-located within a single processing unit, in implementations in which processor(s) 112 include multiple processing units, one or more instructions may be executed remotely from the other instructions.

Although processor computer system 110, electronic storage 130, and client computing device(s) 140 are shown to be connected to interface 102 in FIG. 1, any communication medium may be used to facilitate interaction between any components of system 100. One or more components of system 100 may communicate with each other through hard-wired communication, wireless communication, or both. In various implementations, one or more components of system 100 may communicate with each other through a network. For example, computer system 110 may wirelessly communicate with electronic storage 130. By way of non-limiting example, wireless communication may include one or more of radio communication, Bluetooth communication, Wi-Fi communication, cellular communication, infrared communication, or other wireless communication. Other types of communications are contemplated by the present disclosure.

Reference in this specification to “one implementation”, “an implementation”, “some implementations”, “various implementations”, “certain implementations”, “other implementations”, “one series of implementations”, or the like means that a particular feature, design, structure, or characteristic described in connection with the implementation is included in at least one implementation of the disclosure. The appearances of, for example, the phrase “in one implementation” or “in an implementation” in various places in the specification are not necessarily all referring to the same implementation, nor are separate or alternative implementations mutually exclusive of other implementations. Moreover, whether or not there is express reference to an “implementation” or the like, various features are described, which may be variously combined and included in some implementations, but also variously omitted in other implementations. Similarly, various features are described that may be preferences or requirements for some implementations, but not other implementations.

The language used herein has been principally selected for readability and instructional purposes, and it may not have been selected to delineate or circumscribe the inventive subject matter. Other implementations, uses and advantages of the invention will be apparent to those skilled in the art from consideration of the specification and practice of the invention disclosed herein. The specification should be considered exemplary only, and the scope of the invention is accordingly intended to be limited only by the following claims.

1. A computer-implemented method of performing differential compression of images used to render computer-generated three-dimensional models, the method comprising:
calculating a differential pixel for each pixel of a source image, wherein calculating a first differential pixel for a first pixel of the source image comprises subtracting a corresponding pixel of a reference image from the first pixel of the source image, the reference image comprising an image with the same pixel width and pixel height as the source image;
producing a differential image comprising the differential pixel for each pixel of the source image placed in a position corresponding to a position of a pixel of the source image used to calculate the differential pixel; and
compressing the differential image using a compression method.

2. The computer-implemented method of claim 1, wherein subtracting the corresponding pixel of the reference image from the first pixel of the source image comprises per-component subtraction of RGB components of the corresponding pixel of the reference image from RGB components of the first pixel of the source image.

3. The computer-implemented method of claim 1, the method further comprising applying a color space conversion to each pixel of the source image, wherein the corresponding pixel of the reference image is subtracted from the first pixel of the source image after the color space conversion is applied.

4. The computer-implemented method of claim 3, the method further comprising performing gamma correction prior to applying the color space conversion.

5. The computer-implemented method of claim 1, wherein the compression method comprises a compression method associated with an existing file format, the existing file format comprising one of AVIF, JPEG, and JPEG XL.

6. The computer-implemented method of claim 1, wherein calculating a differential pixel for each pixel of the source image comprises:
calculating a DCT coefficient for each pixel of the source image; and
calculating a DCT coefficient for each pixel of the reference image, wherein subtracting the corresponding pixel of the reference image from the first pixel of the source image comprises subtracting the DCT coefficient for each pixel of the reference image from the DCT coefficient for the corresponding pixel of the source image.

7. The computer-implemented method of claim 1, wherein the source image comprises a texture used to render a three-dimensional model.

8. The computer-implemented method of claim 7, wherein the reference image comprises another texture used to render the three-dimensional model.

9. A system for performing differential compression of images used to render computer-generated three-dimensional models, the system comprising:
one or more processors configured by computer readable instructions to:
calculate a differential pixel for each pixel of a source image, wherein to calculate a first differential pixel for a first pixel of the source image, the one or more processors are configured to subtract a corresponding pixel of a reference image from the first pixel of the source image, the reference image comprising an image with the same pixel width and pixel height as the source image;
produce a differential image comprising the differential pixel for each pixel of the source image placed in a position corresponding to a position of a pixel of the source image used to calculate the differential pixel; and
compress the differential image using a compression method.

10. The system of claim 9, wherein to subtract the corresponding pixel of the reference image from the first pixel of the source image, the one or more processors are configured to perform per-component subtraction of RGB components of the corresponding pixel of the reference image from RGB components of the first pixel of the source image.

11. The system of claim 9, wherein the one or more processors are further configured to apply a color space conversion to each pixel of the source image, wherein the corresponding pixel of the reference image is subtracted from the first pixel of the source image after the color space conversion is applied.

12. The system of claim 11, wherein the one or more processors are further configured to perform gamma correction prior to applying the color space conversion.

13. The system of claim 9, wherein the compression method comprises a compression method associated with an existing file format, the existing file format comprising one of AVIF, JPEG, and JPEG XL.

14. The system of claim 9, wherein to calculate a differential pixel for each pixel of the source image, the one or more processors are configured to:
calculate a DCT coefficient for each pixel of the source image; and
calculate a DCT coefficient for each pixel of the reference image, wherein to subtract the corresponding pixel of the reference image from the first pixel of the source image, the one or more processors are configured to subtracting the DCT coefficient for each pixel of the reference image from the DCT coefficient for the corresponding pixel of the source image.

15. The system of claim 9, wherein the source image comprises a texture used to render a three-dimensional model.

16. The system of claim 15, wherein the reference image comprises another texture used to render the three-dimensional model.

17. A computer-implemented method of decompressing a differential image used to render a computer-generated three-dimensional model, the method comprising:
applying a decompression method to a compressed differential image;
calculating an undifferentiated pixel for each pixel of the decompressed differential image, wherein calculating a first undifferentiated pixel for a first pixel of the decompressed differential image comprises adding a corresponding pixel of a reference image to the first pixel of the decompressed differential image, the reference image comprising an image with the same pixel width and pixel height as a source image used to create the compressed differential image; and
producing an undifferentiated image comprising the undifferentiated pixel for each pixel of the decompressed differential image placed in a position corresponding to a position of a pixel of the reference image used to calculate the undifferentiated pixel, the undifferentiated image comprising a decompressed version of the source image.

18. The computer-implemented method of claim 17, wherein adding the corresponding pixel of the reference image to the first pixel of the decompressed differential image comprises per-component addition of RGB components of the corresponding pixel of the reference image to RGB components of the first pixel of the decompressed differential image.

19. The computer-implemented method of claim 17, the method further comprising applying an inverse color space conversion to each pixel of the undifferentiated image, wherein the corresponding pixel of the reference image is added to the first pixel of the decompressed differential image before the inverse color space conversion is applied.

20. The computer-implemented method of claim 19, the method further comprising performing inverse gamma correction prior to applying the inverse color space conversion.

21. The computer-implemented method of claim 17, wherein the decompression method comprises a method complementary to a compression method associated with an existing file format, the existing file format comprising one of AVIF, JPEG, and JPEG XL.

22. The computer-implemented method of claim 17, wherein calculating an undifferentiated pixel for each pixel of the decompressed differential image comprises:
calculating a DCT coefficient for each pixel of the decompressed differential image; and
calculating a DCT coefficient for each pixel of the reference image, wherein adding the corresponding pixel of the reference image to the first pixel of the decompressed differential image comprises adding the DCT coefficient for each pixel of the reference image to the DCT coefficient for the corresponding pixel of the decompressed differential image.

23. The computer-implemented method of claim 17, wherein the decompression method is complementary to a compression method used to compress the differential image.

24. The computer-implemented method of claim 17, wherein the reference image comprises an image used to create the compressed differential image.

25. A system for decompressing a differential image used to render a computer-generated three-dimensional model, the system comprising:
one or more processors configured by computer readable instructions to:
apply a decompression method to a compressed differential image;
calculate an undifferentiated pixel for each pixel of the decompressed differential image, wherein to calculate a first undifferentiated pixel for a first pixel of the decompressed differential image, the one or more processors are configured to add a corresponding pixel of a reference image to the first pixel of the decompressed differential image, the reference image comprising an image with the same pixel width and pixel height as a source image used to create the compressed differential image; and
produce an undifferentiated image comprising the undifferentiated pixel for each pixel of the decompressed differential image placed in a position corresponding to a position of a pixel of the reference image used to calculate the undifferentiated pixel, the undifferentiated image comprising a decompressed version of the source image.

26. The system of claim 25, wherein to add the corresponding pixel of the reference image to the first pixel of the decompressed differential image, the one or more processors are configured to perform per-component addition of RGB components of the corresponding pixel of the reference image to RGB components of the first pixel of the decompressed differential image.

27. The system of claim 25, wherein the one or more processors are further configured to apply an inverse color space conversion to each pixel of the undifferentiated image, wherein the corresponding pixel of the reference image is added to the first pixel of the decompressed differential image before the inverse color space conversion is applied.

28. The system of claim 27, wherein the one or more processors are further configured to perform inverse gamma correction prior to applying the inverse color space conversion.

29. The system of claim 25, wherein the decompression method comprises a method complementary to a compression method associated with an existing file format, the existing file format comprising one of AVIF, JPEG, and JPEG XL.

30. The system of claim 25, wherein to calculate an undifferentiated pixel for each pixel of the decompressed differential image, the one or more processors are configured to:
calculate a DCT coefficient for each pixel of the decompressed differential image; and
calculate a DCT coefficient for each pixel of the reference image, wherein to add the corresponding pixel of the reference image to the first pixel of the decompressed differential image, the one or more processors are configured to add the DCT coefficient for each pixel of the reference image to the DCT coefficient for the corresponding pixel of the decompressed differential image.

31. The system of claim 25, wherein the decompression method is complementary to a compression method used to compress the differential image.

32. The system of claim 25, wherein the reference image comprises an image used to create the compressed differential image.

33-66. (canceled)
